(19) United States
(12) Patent Application Publication
(10) Pub. No.: US 2024/0000270 A1
(43) Pub. Date: Jan. 4, 2024

(54) SYNCHRONIZATION FOR A MULTIPLE ZONE FOOD PREPARATION DEVICE

(71) Applicant: Instant Brands Holdings Inc., Downers Grove, IL (US)

(72) Inventors: Shuang Xu, Downers Grove, IL (US); Lena Tran, Downers Grove, IL (US)

(73) Assignee: Instant Brands Holdings Inc., Downers Grove, IL (US)

(21) Appl. No.: 17/855,989

(22) Filed: Jul. 1, 2022

(51) Int. Cl. A47J 44/00; A47J 37/06; F24C 7/02; F24C 7/08; F24C 15/00

(52) U.S. Cl. CPC A47J 44/00; A47J 37/0641; F24C 7/02; F24C 7/085; F24C 15/003

(57) ABSTRACT

A food preparation device synchronizes multiple zones or compartments that each have independent settings. The multiple zones have a synchronized finish so that the food preparation for each of the zones finish at substantially the same time. The synchronized finish may be calculated based on the different settings for each of the zones. A preheating phase for a zone can be modified by temperature or time. The synchronization may also be modified based on any interruptions to either zone to maintain the synchronized finish.

### TECHNICAL FIELD OF THE INVENTION

The present invention relates to a food preparation device that synchronizes multiple zones or compartments that each have independent settings.

### BACKGROUND

Food preparation devices may include multiple zones for cooking or preparing different foods or drinks. Those devices may allow for independent setting for each of the zones without an ability to coordinate between the preparation between zones.

### BRIEF SUMMARY

The present invention relates to a method, system or apparatus and/or computer program product for an improved food preparation device that synchronizes multiple zones or compartments that each have independent settings. The multiple zones have a synchronized finish so that the food preparation for each of the zones is synchronized to finish at substantially the same time. The synchronized finish may be calculated based on the different settings for each of the zones. In some embodiments, a preheating phase for a zone can be modified by temperature or time. The synchronization may be modified based on any interruptions to either zone to maintain the synchronized finish.

In one embodiment, a food preparation device includes a first compartment for preparing a first food according to first settings that include a first finishing time; a second compartment for preparing a second food according to second settings that include a second finishing time; and a synchronization circuit configured for synchronizing the first finishing time and the second finishing time. The preparing comprises functions including at least one of a cooking, frying, air frying, baking, roasting, broiling, reheating, steaming, dehydrate, defrosting, or microwaving. Each of the compartments can independently perform each of the functions. The device includes a first message bar for the first compartment for displaying information about the first settings; and a second message bar for the second compartment for displaying information about the second settings. The displaying information about the first settings comprises the first finishing time and the functions for the first compartment, and further wherein the displaying information about the second settings comprises the second finishing time and the functions for the second compartment. The first settings and the second settings each comprise a temperature dependent on the function, wherein the first compartment has a different temperature from the second compartment. The first compartment comprises a first sensor for measuring the first food and the second compartment comprises a second sensor for measuring the second food. The measuring comprises at least a weight or temperature. The synchronization circuit is further configured for calculating a synchronized finish time based on both the first finishing time and the second finishing time, wherein the synchronized finish time comprises one of the first finishing time or the second finishing time. The synchronizing comprises modifying a start time or a pre-heating time for at least one of the first compartment or the second compartment. The pre-heating time is increased in one of the compartments to synchronize the finishing times.

In another embodiment, a dual cooking device includes a first cooking zone with first settings that include a first finishing time; a second cooking zone with second settings that include a second finishing time; and a computer readable medium storing instructions configured to be executed by a processor to synchronize the first finishing time and the second finishing time. The first cooking zone and the second cooking zone each include functions for at least one of a cooking, frying, air frying, baking, roasting, broiling, reheating, steaming, dehydrate, defrosting, or microwaving. Each of the zones can independently perform each of the functions. The device includes a first message bar for the first zone for displaying information about the first settings; and a second message bar for the second zone for displaying information about the second settings. The displaying information about the first settings comprises the first finishing time and the functions for the first zone, and further wherein the displaying information about the second settings comprises the second finishing time and the functions for the second zone. The first zone comprises a first sensor for measuring a weight or temperature of food in the first zone and the second zone comprises a second sensor for measuring a weight or temperature of food in the second zone. The synchronization includes modifying a start time or a pre-heating time for at least one of the first zone or the second zone. The pre-heating time is increased in one of the zones to synchronize the finishing times.

In another embodiment, a method includes receiving an input from a user for cooking settings for either a first cooking zone or a second cooking zone, wherein the cooking settings comprise at least a cooking time and a cooking temperature. The user received input may include cooking settings for both the first cooking zone and the second cooking zone, or the user may be allowed to enter cooking settings for one of the zones and then synchronize the cooking settings for the other zone. This synchronization may be referred as synced cooking. The method further includes a synced finish feature that includes synchronizing, upon a synchronization finish input, the cooking time for the first cooking zone and the cooking time for the second cooking zone. The synchronizing includes modifying a start time or a pre-heating time for at least one of the first cooking zone or the second cooking zone.

In some embodiments, a device includes a processor and a memory, and the processor is configured to read code from the memory and implement any of the embodiments discussed above. In some embodiments, a computer program product comprises a computer-readable program medium code stored thereupon, the code, when executed by a processor, causes the processor to implement any of the embodiments discussed above. In some embodiments, there is an apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any of the embodiments. The above and other aspects and their implementations are described in greater detail in the drawings, the descriptions, and the claims.

### BRIEF DESCRIPTION OF THE DRAWINGS

The figures illustrate principles of the invention according to specific embodiments. Thus, it is also possible to implement the invention in other embodiments, so that these figures are only to be construed as examples. Moreover, in the figures, like reference numerals designate corresponding modules or items throughout the different drawings.

FIG. 1 illustrates a block diagram of a preparation device.

FIG. 2 illustrates a block diagram of a synchronization circuit for the preparation device.

FIG. 3 illustrates a first flow process for synchronization with a preparation device.

FIG. 4 illustrates a flow process for modifying settings for the synchronization with a preparation device.

FIG. 5 illustrates a chart of different settings for a preparation device.

FIG. 6 illustrates an example of multiple zone synchronization when preheating occurs with empty zones.

FIG. 7 illustrates an example of multiple zone synchronization with food added before preheating.

FIG. 8 illustrates an example of multiple zone synchronization with zone measurements that include dynamic time adjustment after cooking.

FIG. 9 illustrates an example of multiple zone synchronization with different cooking programs.

FIG. 10 illustrates an example of multiple zone synchronization with no interruptions when food is added before preheating.

FIG. 11 illustrates an example of multiple zone synchronization with interruptions.

### DETAILED DESCRIPTION OF THE DRAWINGS AND PREFERRED EMBODIMENTS

By way of introduction, the disclosed embodiments relate to an improved food preparation device that synchronizes multiple zones or compartments that each have independent settings. The multiple zones have a synchronized finish so that the food preparation for each of the zones is synchronized to finish at substantially the same time. The synchronized finish may be calculated based on the different settings for each of the zones. In some embodiments, a preheating phase for a zone can be modified by temperature or time. The synchronization may be modified based on any interruptions to either zone to maintain the synchronized finish.

FIG. 1 illustrates a block diagram of a preparation device 102. The preparation device 102 may include multiple zones. Each zone may be an independent food preparation compartment. Examples of a preparation device include food preparation functions, such as cooking, frying, microwaving, roasting, reheating, steaming, dehydrate, broiling, defrosting, baking, etc. The preparation device 102 may be an air fryer, microwave, oven, steamer, pressure cooker, slow cooker, coffee maker, blender, grill, or any combination of those. Each zone may include a combination of functions or there may be different functions for different zones. In some embodiments, the preparation device may also include beverage preparation, but will be described as food preparation for simplicity.

The zones may be referred to as baskets, compartments, sections, containers, or areas. In one embodiment, there may be two zones, such as the first preparation zone 104 and the second preparation zone 106. Each zone can be independently controlled with different functions and settings. Although this embodiment illustrates two zones, in other embodiments, there may be three or more zones. The examples are described with two zones for simplicity.

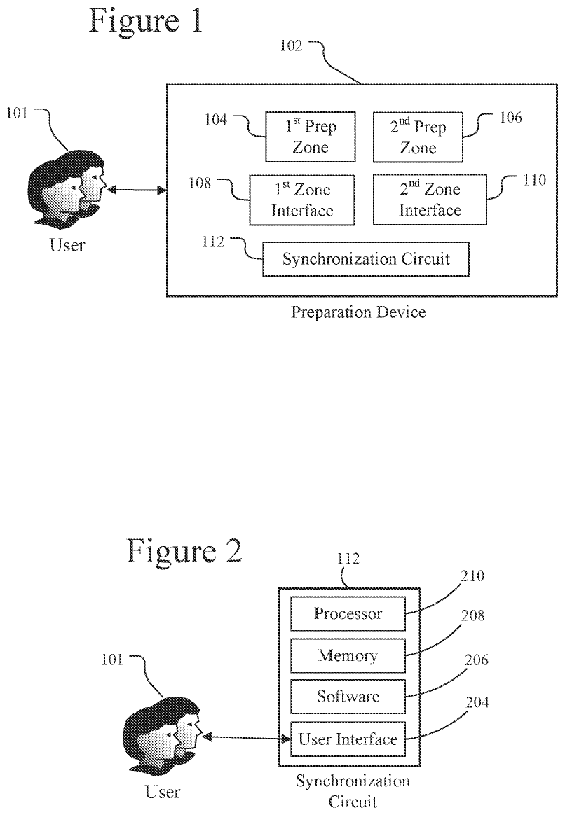

Each zone may have its own interface that includes functionality for receiving input and displaying output with a user 101. Examples of this functionality are described below with respect to the user interface 204 in FIG. 2. The first preparation zone 104 may include a first zone interface 108, while the second preparation zone 106 may include a second zone interface 110.

The zones can each have different foods that are prepared with different functions. Despite having different functions, the synchronization circuit 112 can be used to synchronize a finish time for the preparation device so that the food from each zone is finished at the same time. This may be referred to as Synched Finish. The settings between zones can also be synchronized by the synchronization circuit 112 so that an input of the first settings for the first zone can be copied for the second zone. This may be referred to as Synched Cooking. The synchronization circuit 112 is further described with respect to FIG. 2.

FIG. 2 illustrates a block diagram of the synchronization circuit 112 of the preparation device 102. The synchronization circuit 112 may be referred to as a computing device, processor, circuit board, chip, or microcomputer through which computations or processes are performed. In one embodiment, the synchronization circuit 112 may be software that runs on a computing device as shown in FIG. 2. The synchronization circuit 112 may include a processor 210, a memory 208, software 206 and/or a user interface 204. In alternative embodiments, the synchronization circuit 112 may be multiple devices to provide different functions and it may or may not include all of the user interface 204, the software 206, the memory 208, and/or the processor 210. While described as synchronization circuit 112, it may include functionality for controlling other aspects of the preparation zones 104, 106 other than just synchronization. In one embodiment, there may be single circuit or processor for controlling synchronization and the functions/settings for each zone. In other embodiments, there may be a separate processor from the synchronization circuit 112. For simplicity, the functions/settings are described as being controlled by the synchronization circuit 112.

The user interface 204 may include the first zone interface 108 and/or the second zone interface 110 and include a display, which may be separate from the synchronization circuit 112, or it may provide inputs to and outputs from the synchronization circuit 112. The preparation device 102 may include a user interface 204 for providing information to the user 101. In one embodiment, the user interface 204 may be a display, such as a message bar, coupled with the processor 210 and configured to display an output from the processor 210. The display (not shown) may be a liquid crystal display (LCD), an organic light emitting diode (OLED), a flat panel display, a solid state display, a cathode ray tube (CRT), or other now known or later developed display device for outputting determined information. The display may act as an interface for the user to see the functioning of the processor 210, or as an interface with the software 206 for providing feedback or information about the preparation function/settings.

In some embodiments, the user interface 204 may also provide a mechanism for the user 101 to interact with the preparation device 102, such as by providing commands with a user input. The commands may include functions/settings for each of the zones 104, 106 that can be set by the user 101. In some embodiments, the user interface 204 may include buttons, touch screen display, a keypad or a cursor control device, a remote control, a wireless device (e.g. computing device, smartphone, tablet, etc.) or any other device operative to allow a user or administrator to interact with the preparation device 102. In some embodiments, the interface may include a voice control or audio input for receiving commands and/or providing feedback. In other embodiments the user interface 204 may include inputs for scanning (e.g. scanning a food/recipe code) or sensor inputs (e.g. scale, temperatures, etc.), or any other mechanism to accept user information about the food being prepared. This may include any information about what is being prepared/cooked (including but not limited to a recipe) that can help define the proper cooking time, which will then improve synchronization.

The user interface 204 including the first zone interface 108 and the second zone interface 110 may receive settings from the user 101 for the respective preparation zones 104, 106. In other words, the user 101 can enter the food preparation settings (e.g. function, time, temperature, pressure, weight, humidity, etc.) for each of the zones through the interface, which may be separate from the synchronization circuit 112 in some embodiments. The display (e.g. message bar) may display information about the cooking settings or functions of each zone independently. For example, the function, temperature, and/or time remaining may be displayed for each of the zones. There may be separate displays for each zone as illustrated in FIG. 1 as independent zone interfaces 108, 110.

The processor 210 in the synchronization circuit 112 may include a central processing unit (CPU), a graphics processing unit (GPU), a digital signal processor (DSP) or other type of processing device. The processor 210 may be one or more general processors, digital signal processors, application specific integrated circuits, field programmable gate arrays, servers, networks, digital circuits, analog circuits, combinations thereof, or other now known or later developed devices for analyzing and processing data. The processor 210 may operate in conjunction with a software program (i.e. software 206), such as code generated manually (i.e., programmed). The software 206 may include functionality for the setting up and running the preparation zones 104, 106 in addition to the synchronization described below.

The processor 210 may be coupled with the memory 208, or the memory 208 may be a separate component. The software 206 may be stored in the memory 208. The memory 208 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 208 may include a random access memory for the processor 210. Alternatively, the memory 208 may be separate from the processor 210, such as a cache memory of a processor, the system memory, or other memory. The memory 208 is operable to store instructions executable by the processor 210.

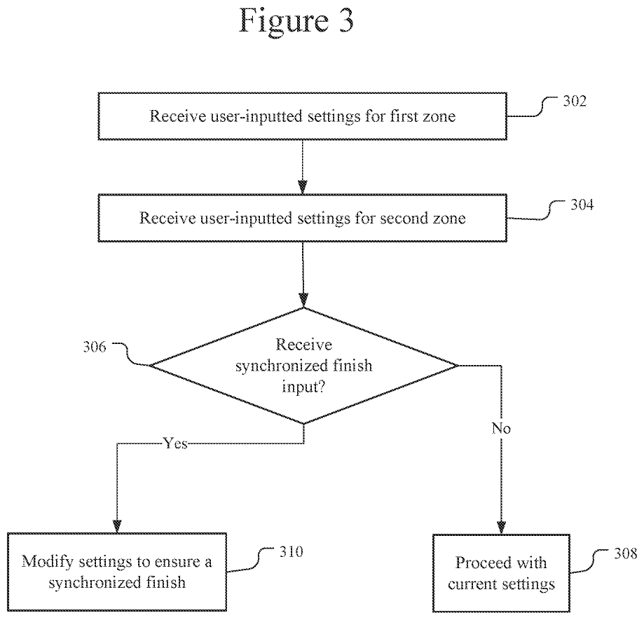

The functions, acts or tasks illustrated in the figures (e.g. FIGS. 3-4, 6-12) or described herein may be performed by the programmed processor executing the instructions stored in the software 206 or the memory 208. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 210 is configured to execute the software 206.

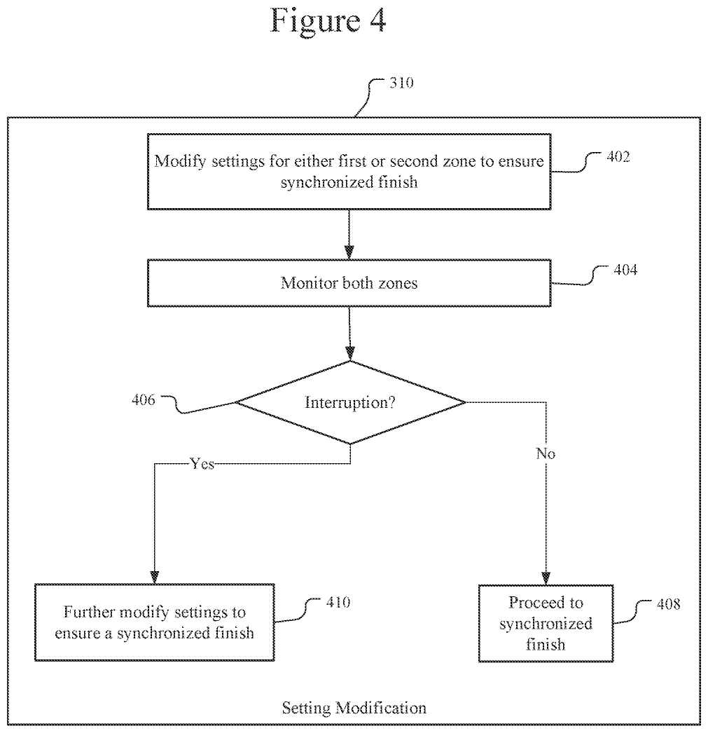

The synchronization circuit 112 may be used for implementing the processes shown in the embodiments of FIGS. 3-4, 6-12. FIG. 3 illustrates a first flow process for synchronization with a preparation device. In block 302, the settings for a first zone are received from a user. As described with respect to FIG. 2, the settings may be received through a user interface, which may include buttons or other inputs (e.g. user interface 204). The settings may include the type of function (e.g. cooking, air frying, microwaving, defrosting, etc.) along with specific cooking instructions (e.g. time, temperature, pressure, humidity, etc.). The settings may be input by the user or the preparation device may automatically determine appropriate settings based on some user input or based on sensors regarding the food (e.g. weight, temperature, density, etc.) In some embodiments, the user could identify the food type and the settings are determined based on food type, along with sensed variables, such as weight and temperature. The initial settings received may be referred to as cooking settings, which may include any changes/settings before the user starts preparing. Block 310 and FIG. 4 discussed below describe changes to the settings which may occur after the preparing has already started.

The settings for the second zone in block 304 may also be user-input in a similar manner as the user-inputted settings for the first zone in block 302. There may be a separate user interface for each zone, or there may be a single user interface for different zones. In some embodiments, there may be a synchronization feature for the settings that may be referred to as Synched Cook, in which the user can copy the settings from one zone to another zone. In other words, the settings for the second zone in block 304 may be copied from the user-inputted settings for the first zone when the user indicates a desire for synched cooking.

In one embodiment, the user-inputted settings for the second zone in block 304 may occur after the preparation for the first zone begins. Specifically, the user may enter the settings for the first zone in block 302 and the food preparation begins (e.g. the first zone begins cooking, pre-heating, etc.) before the user later decides to use the second zone. In this embodiment, the user may be allowed to select the synchronized finish feature (in block 306) even though the first zone has already started. The synchronization may need to be adjusted accordingly. In some embodiments, there may not be enough remaining time for the cooking of the first zone to synchronize the finish for the second zone and the user will be notified accordingly. Otherwise, the synchronization calculation occurs and adjusts any necessary settings for both zones to synchronize the finish as described below.

After the settings are received for the zones, the preparation device can begin the preparation process. In one example, where one zone is cooking chicken nuggets and another zone is cooking french fries, it may be desirable to have them finished at the same time so they can be served hot at the same time. This feature may be referred to as a synched finish or synchronized finish feature as in block 306. If the user does not select synchronized finish in block 306, then the respective settings for each zone are utilized in block 308 and the timing of each zone is not synchronized.

In block 310, the user has selected synchronized finish in block 306 (e.g. click a Sync Finish button), so the preparation device modifies settings to ensure the synchronized finish. The cooking settings may be different which results in different cooking times, so in order to synchronize the finish, the preparation device must determine how to modify settings to synchronize the zones in block 310. As described, there may be user-inputted settings that may also be referred to as cooking settings that are not modified and include a temperature and time in one embodiment. The cooking settings may not be modified in some embodiments, but the modification is for settings other than the user-inputted cooking settings, including an initial wait time and/or pre-heating time that are modified to achieve the synchronized finish. In other embodiments, sensors may be monitored to adjust any and all settings to achieve a synchronized finish between zones. FIG. 4 further illustrates the modification of settings shown in block 310.

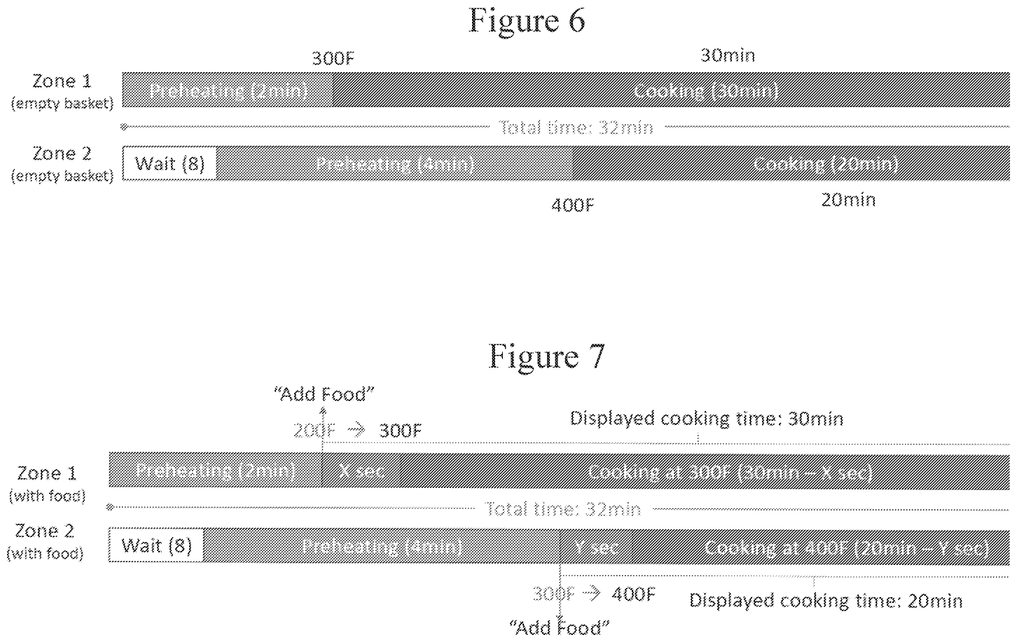

FIG. 4 illustrates a flow process for modifying settings 310 for the synchronization with a preparation device. In block 402, either settings for the first zone and/or the second zone are modified to ensure synchronized finish. In some embodiments, the setting for both zones are modified. The settings may refer to timing (e.g. start point, duration, etc.) without modifying the end cooking results, which may include and be referred to as cooking setting. There may an adjustment to one or both zones to ensure the cooking results are correct and the timing is synchronized. Examples of the modification are further described with respect to FIGS. 6-12 and may include starting cooking later or modifying a pre-heating function (e.g. pre-heat time, pre-heat temperature, pre-heat heating rate, etc.). In block 404, the zones may be monitored. The monitoring may include sensors that track the status of the preparation (e.g. weight, temperature, pressure, humidity, etc.). This monitoring may be used an input for updating the synchronization (not shown), including further changing the settings. For example, a food item may be cooking slower than expected (temperature raises slower), so the synchronization may adjust the settings of the zone to improve, or may just slow the cooking of the other zone to ensure a synchronized finish.

An interruption to cooking may make a synchronized finish difficult. For example, the opening of a door or removing of a tray from one zone stops the cooking for that zone, but the other zone may continue cooking. The preparation device can also monitor for an interruption in block 406. If there is no interruption, then the preparation device can proceed to a synchronized finish in block 408. As mentioned, this may be subject to monitoring both zones (in block 404) to provide any setting updates as necessary. However, if an interruption is detected in block 406, the preparation device may need to further modify settings to maintain a synchronized finish in block 410. This may include monitoring cooking status, changing settings for one or both zones, and/or pausing cooking in the other zone while the interruption is occurring. Examples of the setting modification are further described with respect to FIGS. 6-12 and some examples include interruptions. In some embodiments, an interruption may interrupt the synchronized finish settings and the user may be required to provide input on proceeding with either an unsynchronized finish or options for a synchronized finish.

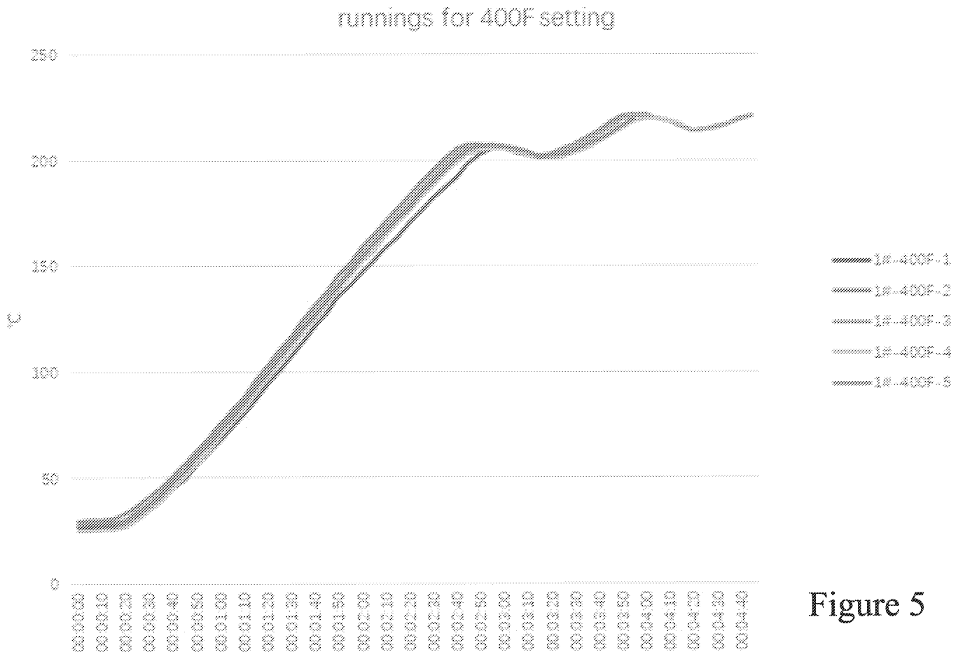

FIG. 5 illustrates a chart of different settings for a preparation device. This chart is one example of how to calculate and predict the needed time in a Preheating stage for the preparation device. FIG. 5 illustrates a temperature (y-axis) over time (x-axis) for pre-heating. In this example, the cooking setting is set at 400 degrees Fahrenheit. This curve is used for determine how long preheating can take at different temperature levels. This can be used for modifying the preheating time for synchronization. Specifically, this example may be used to predict pre-heating time with an empty basket. The synchronization circuit can utilize this information for making adjustments to the pre-heating time and temperature which can be used for synchronizing a finish between zones. Utilizing this pre-heating curve, the needed pre-heating time may be calculated as 115/150 times the target temperature. This calculation may be made for both zones. When the calculated time for Zone 1 is greater than the calculated time for Zone 2, then Zone 1 starts before Zone 2 by an amount that is the different between the calculated times. In addition, to starting one zone later than another, the pre-heating time may be another setting that can be modified to ensure a synchronized finish. The chart in FIG. 5 can vary between each device, so it may be unique to a device for making an accurate determination of preheating time. Specifically, the variance from device to device may also include variance for capacity, material, and heating performance change. However, the linear relationship can be applied despite this variance in order to calculate the required preheating time based on a set temperature.

FIG. 6 illustrates an example of multiple zone synchronization when preheating occurs with empty zones. In this example, both zones are empty. Zone 1 is set to cook at 300 F, while Zone 2 cooks at 400 F. The cooking time (30 minutes for Zone 1 and 20 minutes for Zone 2) may be set by the user or determined by the device based on inputs (type of food, sensor measurements, etc.). In this example, Zone 2 includes a wait period (8 minutes) combined with a longer preheating time (4 minutes) to ensure that both zones have a synchronized finish. The preheating times are different because the temperatures are different. However, in some embodiments, the preheating time can also be modified to synchronize the finish. The overall times are shown as:
Zone 1: 2 minutes preheating+30 minutes cooking=32 total minutes
Zone 2: 8 minute wait+4 minutes preheating+20 minutes cooking=32 total minutes.

FIG. 6 illustrates a combination of adding a wait time and modifying the preheating time to ensure a synchronized finish. Merely modifying the temperature and/or time for the cooking phase could be used for synchronization, but that would impact the quality of the cooking (i.e. cooking at a high temperature may be faster but dry out the food). Accordingly, the synchronization determines an appropriate wait time and preheating time to still maintain the proper cooking time at the proper temperature.

FIG. 7 illustrates an example of multiple zone synchronization with food added before preheating. In this example, the temperatures and cooking times of Zone 1 and Zone 2 are the same as shown in FIG. 6. However, when the user adds food, it may take longer to get to the target temperatures. If the user adds food, then starts preheating, at the calculated time, the actual temperature will be lower than the target temperature (e.g. target temperature for preheating in FIG. 5 is for an empty zone/basket). In other words, the addition of food before preheating causes the preparation device to operate differently from the curve shown in FIG. 5. When the cooking time countdown starts, the heating continues until it reaches the target temperature.

The preparation device may prompt the user to add food at the end of preheating, however, in FIG. 7, the user added the food at the beginning. As a result, the target temperature is not reached and there is an “X sec” time frame for getting to the target temperature in Zone 1 and a “Y sec” time frame for getting to the target temperature in Zone 2. In this example, total time and cooking time is the same. In alternative embodiments, the preparation device may adjust the preheating time and/or cooking time based on the presence of food during preheating. This may be based on sensor measurements of temperature, weight, etc.

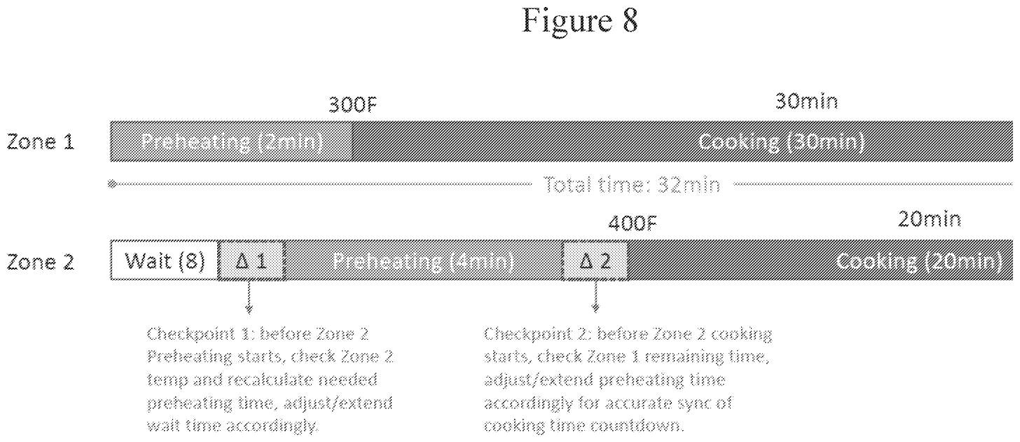

FIG. 8 illustrates an example of multiple zone synchronization with zone measurements that include dynamic time adjustment after cooking. This chart may have the dynamic time adjustment that can occur after preparation begins. The second zone may be affected/heated before it enters preheating, so the predicted start/preheating time may be adjusted in real time for accuracy and cooking results. In the preparation device, the zones may be adjacent, so preheating one zone may also raise the temperature of the other zone due to proximity to the preheating. In this instance, the second zone starts at a temperature above room temperature and may require less preheating. FIG. 8 illustrates two checkpoints that are added to dynamically adjust time based on the heating. These checkpoints may utilize a measured temperature to dynamically adjust preheating and/or cooking time based on the measured temperature being higher than the expected temperature. At the first checkpoint, before zone 2 preheating starts, the zone 2 temperature is determined and there may be a recalculation for preheating time if the zone 2 temperature is higher than expected. Specifically, if the temperature at checkpoint 1 is high, then the preheating time can be reduced (e.g. wait time is increased) and/or started later than planned. At checkpoint 2, before the zone 2 cooking starts, the zone 2 remaining time is checked and the preheating time may be adjusted/extended depending on the temperature.

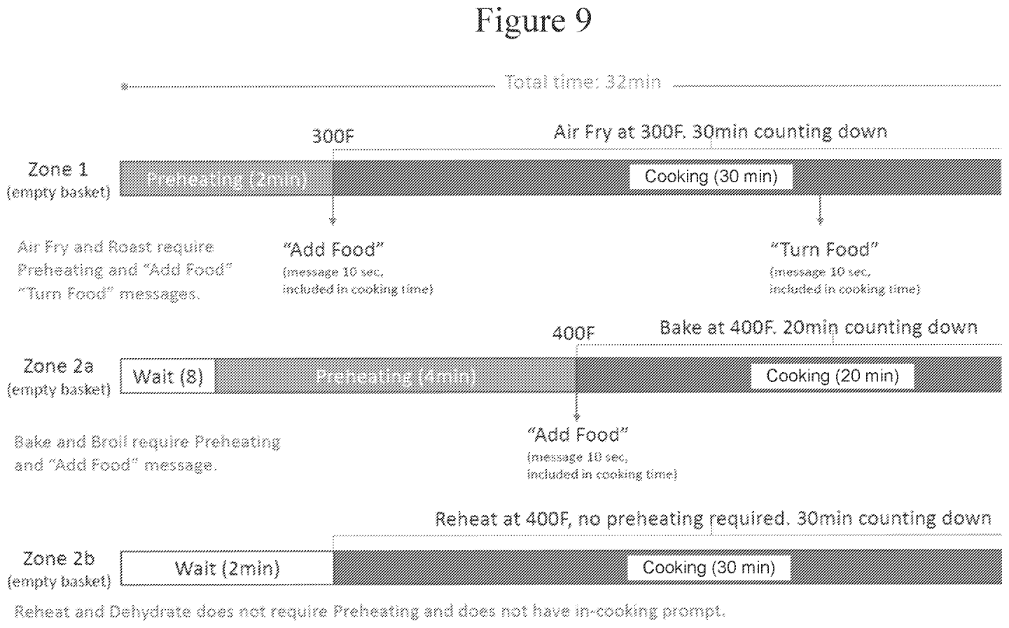

FIG. 9 illustrates an example of multiple zone synchronization for different preparation/cooking programs. It may occur with no interruptions when food is added after preheating. This chart illustrates an overall time calculation for different preparation/cooking programs. For example, different cooking programs may or may not have preheating stage, and they may or may not have instructions during cooking. Zone 1 may include a cooking function (e.g. Air Fry or Roast) that may require preheating and provides prompts with an “Add Food” message and a “Turn Food” message for the user as shown in FIG. 9. Depending on the function of Zone 2, the wait time may be changed. For the Zone 2a example, the function is a Bake or Broil which does require preheating and an “Add Food” message. However, for the Zone 2b example, the function is Reheat or Dehydrate, which does not require preheating or any prompts. Accordingly, the wait time is extended to ensure that the Zone 2b finish time matches with Zone 1.

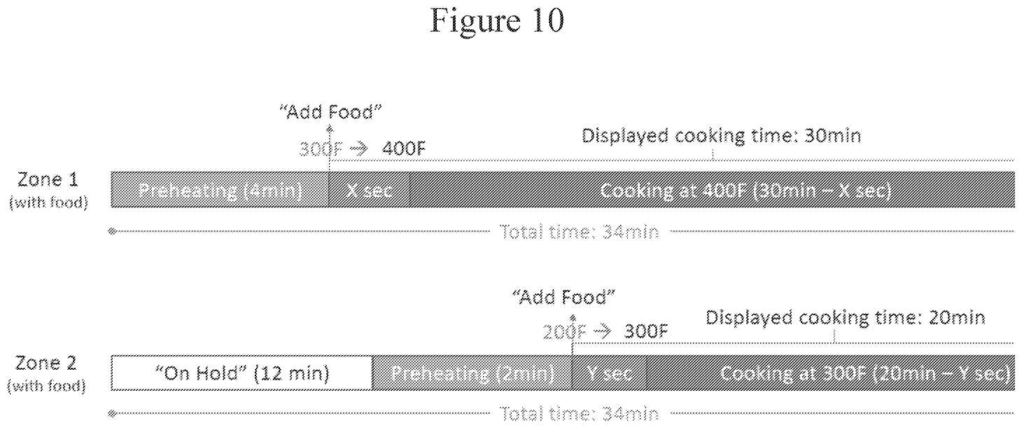

FIG. 10 illustrates an example of multiple zone synchronization with no interruptions when food is added before preheating. If the user adds food, then starts preheating, at the calculated time the actual zone temperature will be lower than the target temperature. When the cooking time countdown starts, the zone heating continues until it reaches the target temperature. In FIG. 10, the cooking time at the target temp is X sec shorter but the food was in the zone (i.e. heated in the basket) during preheating. The “X sec” and “Y sec” modifications to the settings may be based on measured parameters, such as the temperature of the zone and/or temperature of the food.

FIG. 4 included an interruption determination 406. The interruption may include opening a zone (e.g. opening a basket/door) that is in preheating or cooking mode. This may result in the heating stopping with a message to the user (e.g. on the message bar) saying “Close Basket” with a warning beep. In some embodiments, the cooking in Zone 2 is then stopped an the message bar for Zone 2 displays “Paused.” If the user does not return within X min, cooking (in both zones) may be cancelled. X may be 5 minutes or a different value that could depend on the type of food and where in the process the zone is (e.g. X=5 minutes if nearing end of cooking, but X=10 minutes during preheating). Otherwise, the cooking/time continues with the heat ramping up to resume the previous state:
If Zone 1 was in preheating, sync time and heating may continue to complete the preheating stage.
   If Zone 2 was in waiting, sync time continues after the interruption.
   If Zone 2 was in preheating, sync time and heating continue to complete the preheating stage.
   If Zone 2 was in cooking, cook time countdown and heating continue after the interruption.
If Zone 1 was in cooking, cook time countdown and heating continue after the interruption.
   If Zone 2 was in waiting, sync time continues after the interruption.
   If Zone 2 was in preheating, sync time and heating continue to complete the preheating stage.
   If Zone 2 was in cooking, cook time countdown and heating continue after the interruption.
If Zone 2 basket is also opened during the Zone 1 “Basket Open” window, then the interruption is combined into one. If either interruption or the combined interruption is over X minutes, the cooking (in both zones) may be cancelled.
If multiple interruptions happen in sequence, the scenarios described above may apply to each interruption.

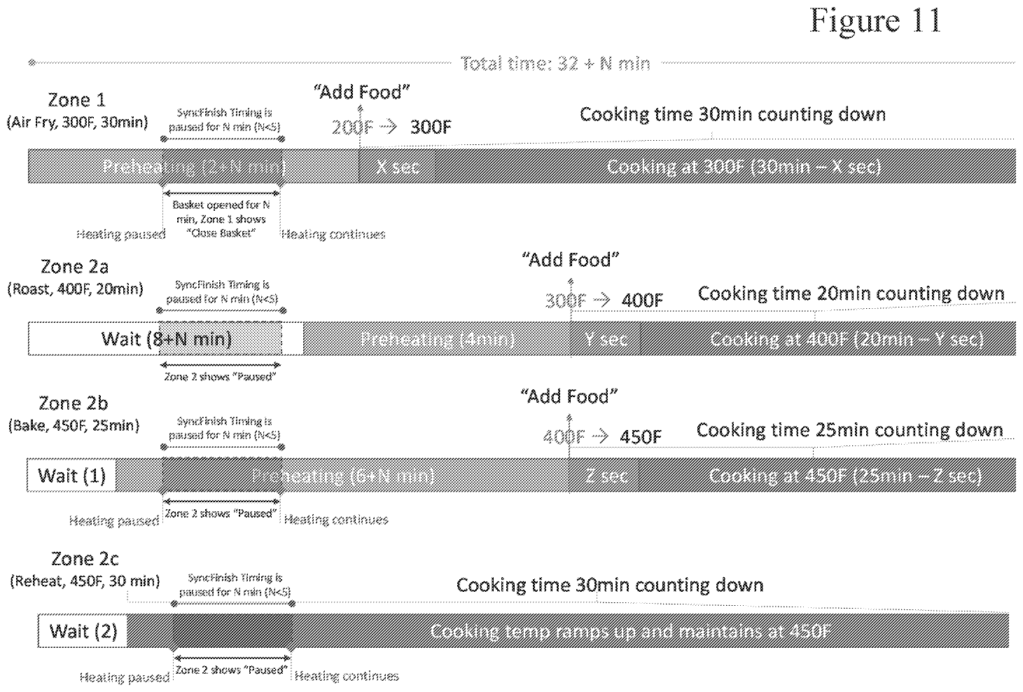

FIG. 11 illustrates an example of multiple zone synchronization with interruptions. In this example, Zone 1 is opened (“interrupted”) for N minutes, which interrupts the cooking of Zone 1 and interrupts the synchronized finish feature. In one embodiment, Zone 2 is paused during this interruption time. This example, shows two different examples for Zone 2, with Zone 2a including a roast at 400 F for 20 minutes, while Zone 2b includes a bake at 450 F for 25 minutes. For Zone 2a, there is a wait period of 8 minutes plus the extra N minutes for the interruption. Likewise, for Zone 2b, the preheating is increased from 6 minutes to 6+N minutes to account for the interruption. The total time increases by N minutes. For Zone 2c, there is a reheat function at 450 F for 30 minutes. In this example, the cooking temperature ramps up and maintains the temperature. If Zone 2 is also opened when Zone 1 is open, the interruption window is then N=A (Zone 1 open time)+B (Zone 2 open time). If A, B, or A+B is over X min, cooking may be cancelled in both zones. This may apply to multiple interruptions, with the total time being the estimated cooking time combined with the sum of all interruption time.

The meaning of specific details should be construed as examples within the embodiments and are not exhaustive or limiting the invention to the precise forms disclosed within the examples. One skilled in the relevant art will recognize that the invention can also be practiced without one or more of the specific details or with other methods, implementations, modules, entities, datasets, etc. In other instances, well-known structures, computer-related functions or operations are not shown or described in detail, as they will be understood by those skilled in the art.

The discussion above is intended to provide a brief, general description of a suitable computing environment (which might be of different kind like a client-server architecture or an Internet/browser network) in which the invention may be implemented. The invention will be described in general context of computer-executable instructions, such as software modules, which might be executed in combination with hardware modules, being executed by different computers in the network environment. Generally, program modules or software modules include routines, programs, objects, classes, instances, components, data structures, etc., that perform particular tasks or implement particular abstract data types. Computer-executable instructions, associated data structures and program modules represent examples of the program code means for executing steps of the method described herein. The particular sequence of such executable instructions, method steps or associated data structures only represent examples of corresponding activities for implementing the functions described therein. It is also possible to execute the method iteratively.

Those skilled in the art will appreciate that the invention may be practiced in a network computing environment with many types of computer system configurations, including personal computers (PC), hand-held devices (for example, smartphones), multi-processor systems, microprocessor-based programmable consumer electronics, network PCs, minicomputers, mainframe computers, laptops and the like. Further, the invention may be practiced in distributed computing environments where computer-related tasks are performed by local or remote processing devices that are linked (either by hardwired links, wireless links or by a combination of hardwired or wireless links) through a communications network. In a distributed computing environment, program modules may be located in local or remote devices, memory systems, retrievals or data storages.

Generally, the method according to the invention may be executed on one single computer or on several computers that are linked over a network. The computers may be general purpose computing devices in the form a conventional computer, including a processing unit, a system memory, and a system bus that couples various system components including system memory to the processing unit. The system bus may be any one of several types of bus structures including a memory bus or a memory controller, a peripheral bus and a local bus using any of a variety of bus architectures, possibly such which will be used in clinical/medical system environments. The system memory includes read-only memory (ROM) and random access memories (RAM). A basic input/output system (BIOS), containing the basic routines that have the functionality to transfer information between elements within the computer, such as during start-up, may be stored in one memory. Additionally, the computer may also include hard disc drives and other interfaces for user interaction. The drives and their associated computer-readable media provide non-volatile or volatile storage of computer executable instructions, data structures, program modules and related data items. A user interface may be a keyboard, a pointing device or other input devices (not shown in the figures), such as a microphone, a joystick, a mouse. Additionally, interfaces to other systems might be used. These and other input devices are often connected to the processing unit through a serial port interface coupled to system bus. Other interfaces include a universal serial bus (USB). Moreover, a monitor or another display device is also connected to the computers of the system via an interface, such as video adapter. In addition to the monitor, the computers typically include other peripheral output or input devices (not shown), such as speakers and printers or interfaces for data exchange. Local and remote computer are coupled to each other by logical and physical connections, which may include a server, a router, a network interface, a peer device or other common network nodes. The connections might be local area network connections (LAN) and wide area network connections (WAN) which could be used within intranet or internet. Additionally, a networking environment typically includes a modem, a wireless link or any other means for establishing communications over the network.

Moreover, the network typically comprises means for data retrieval, particularly for accessing data storage means like repositories, etc. Network data exchange may be coupled by means of the use of proxies and other servers.

The example embodiments are to be considered in all respects only as illustrative and not restrictive. The scope of the invention is, therefore, indicated by the appended claims rather than by this description. All changes which come within the meaning and range of equivalency of the claims are to be embraced within their scope.

We claim:

1. A food preparation device comprising:
a first compartment for preparing a first food according to first settings that include a first finishing time;
a second compartment for preparing a second food according to second settings that include a second finishing time; and
a synchronization circuit configured for synchronizing the first finishing time and the second finishing time.

2. The device of claim 1, wherein the preparing comprises functions including at least one of a cooking, frying, air frying, baking, roasting, broiling, reheating, steaming, dehydrate, defrosting, or microwaving.

3. The device of claim 2, wherein each of the compartments can independently perform each of the functions.

4. The device of claim 2, further comprising:
a first message bar for the first compartment for displaying information about the first settings; and
a second message bar for the second compartment for displaying information about the second settings.

5. The device of claim 4, wherein the displaying information about the first settings comprises the first finishing time and the functions for the first compartment, and further wherein the displaying information about the second settings comprises the second finishing time and the functions for the second compartment.

6. The device of claim 2, wherein the first settings and the second settings each comprise a temperature dependent on the function, wherein the first compartment has a different temperature from the second compartment.

7. The device of claim 1, wherein the first compartment comprises a first sensor for measuring the first food and the second compartment comprises a second sensor for measuring the second food, wherein the measuring comprises at least a weight or temperature.

8. The device of claim 1, wherein the synchronization circuit is further configured for:
calculating a synchronized finish time based on both the first finishing time and the second finishing time, wherein the synchronized finish time comprises one of the first finishing time or the second finishing time.

9. The device of claim 1, wherein the synchronizing comprises modifying a start time or a pre-heating time for at least one of the first compartment or the second compartment.

10. The device of claim 9, wherein the pre-heating time is increased in one of the compartments to synchronize the finishing times.

11. A dual cooking device comprising:
a first cooking zone with first settings that include a first finishing time;
a second cooking zone with second settings that include a second finishing time; and
a computer readable medium storing instructions configured to be executed by a processor to synchronize the first finishing time and the second finishing time.

12. The device of claim 11, wherein the first cooking zone and the second cooking zone each include functions for at least one of a cooking, frying, air frying, baking, roasting, broiling, reheating, dehydrate, steaming, defrosting, or microwaving.

13. The device of claim 12, wherein each of the zones can independently perform each of the functions.

14. The device of claim 12, further comprising:
a first message bar for the first zone for displaying information about the first settings; and
a second message bar for the second zone for displaying information about the second settings.

15. The device of claim 11, wherein the displaying information about the first settings comprises the first finishing time and the functions for the first zone, and further wherein the displaying information about the second settings comprises the second finishing time and the functions for the second zone.

16. The device of claim 11, wherein the first zone comprises a first sensor for measuring a weight or temperature of food in the first zone and the second zone comprises a second sensor for measuring a weight or temperature of food in the second zone.

17. The device of claim 11, wherein the synchronize further comprises:
modifying a start time or a pre-heating time for at least one of the first zone or the second zone.

18. The device of claim 17, wherein the pre-heating time is increased in one of the zones to synchronize the finishing times.

19. A method comprising:
receiving an input for cooking settings for either a first cooking zone or a second cooking zone, wherein the cooking settings comprise at least a cooking time and a cooking temperature;
receiving, when the settings are not synchronized between the first and second cooking zones, an input for settings for the other of the first cooking zone or the second cooking zone; and
synchronizing, upon a synchronization finish input, the cooking time for the first cooking zone and the cooking time for the second cooking zone.

20. The method of claim 19, wherein the synchronizing further comprises:
modifying a start time or a pre-heating time for at least one of the first cooking zone or the second cooking zone.
